(19) United States
(12) Patent Application Publication
(10) Pub. No.: US 2024/0364863 A1
(43) Pub. Date: Oct. 31, 2024

(54) BI-PREDICTIVE BLOCK VECTOR WITH CU-LEVEL WEIGHT IN IBC

(71) Applicant: Tencent America LLC, Palo Alto, CA (US)

(72) Inventors: Lien-Fei CHEN, Palo Alto, CA (US); Roman CHERNYAK, Palo Alto, CA (US); Xiaozhong XU, Palo Alto, CA (US); Shan LIU, Palo Alto, CA (US)

(21) Appl. No.: 18/643,957

(22) Filed: Apr. 23, 2024

Related U.S. Application Data
(60) Provisional application No. 63/461,877, filed on Apr. 25, 2023.

(51) Int. Cl. H04N 19/105; H04N 19/132; H04N 19/159; H04N 19/172; H04N 19/176; H04N 19/593; H04N 19/70

(52) U.S. Cl. CPC H04N 19/105; H04N 19/132; H04N 19/159; H04N 19/172; H04N 19/176; H04N 19/593; H04N 19/70

(57) ABSTRACT

Various implementations described herein include methods and systems for coding video. In one aspect, a video bitstream includes a current image frame and a first syntax element for a bi-predictive intra block copy (IBC) mode. Based on the first syntax element, it is determined that a current coding block of the current image frame is coded with two reference coding blocks located in a reconstructed portion of the current image frame according to the bi-predictive IBC mode. The two reference coding blocks corresponding to the current coding block are identified in the reconstructed portion of the current image frame. A target weight associated with the two reference coding blocks is adaptively determined for the current coding block, and used to combine the two reference coding blocks and predict the current coding block. The current image frame is reconstructed, and includes the current coding block.

### RELATED APPLICATIONS

This application claims priority to U.S. Provisional Patent Application No. 63/461,877, entitled “Bi-Predictive Block Vector With CU-Level Weight in IBC,” filed Apr. 25, 2023, which is hereby incorporated by reference in its entirety.

### TECHNICAL FIELD

The disclosed embodiments relate generally to video coding, including but not limited to systems and methods for predicting image samples from video data.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

As mentioned above, encoding (compression) reduces the bandwidth and/or storage space requirements. As described in detail later, both lossless compression and lossy compression can be employed. Lossless compression refers to techniques where an exact copy of the original signal can be reconstructed from the compressed original signal via a decoding process. Lossy compression refers to coding/decoding process where original video information is not fully retained during coding and not fully recoverable during decoding. When using lossy compression, the reconstructed signal may not be identical to the original signal, but the distortion between original and reconstructed signals is made small enough to render the reconstructed signal useful for the intended application. The amount of tolerable distortion depends on the application. For example, users of certain consumer video streaming applications may tolerate higher distortion than users of cinematic or television broadcasting applications. The compression ratio achievable by a particular coding algorithm can be selected or adjusted to reflect various distortion tolerance: higher tolerable distortion generally allows for coding algorithms that yield higher losses and higher compression ratios.

The present disclosure describes methods, systems, and non-transitory computer-readable storage media for applying a bi-predictive intra block copy (IBC) mode to predict a current coding block. The current coding block is predicted with two block vectors (BV) identifying two reference coding bocks. A target weight is adaptively identified to combine samples of the two reference coding blocks, thereby enhancing flexibility of the bi-predictive IBC mode. In some embodiments, the target weight is selected from a list of predefined weights using an index signaled via a video bitstream. Alternatively, in some embodiments, the target weight is selected from a list of predefined weights based on a template matching cost. In some embodiments, the target weight is adaptively determined based on template matching costs of the reference coding blocks. The bi-predictive IBC mode using an adaptive weight improves the coding efficiency and accuracy of video content materials compared with the bi-predictive IBC mode that does not use the adaptive weight.

In accordance with some embodiments, a method of video decoding is provided. The method includes receiving a video bitstream including a current image frame, wherein the video bitstream comprises a first syntax element for a bi-predictive IBC mode. The method further includes, based on the first syntax element, determining that a current coding block of the current image frame is coded with two reference coding blocks located in a reconstructed portion of the current image frame according to the bi-predictive IBC mode. The method further includes identifying the two reference coding blocks corresponding to the current coding block in the reconstructed portion of the current image frame, adaptively determining, for the current coding block, a target weight associated with the two reference coding blocks, combining the two reference coding blocks based on the target weight to predict the current coding block, and reconstructing the current image frame including the current coding block.

In accordance with some embodiments, a method of video encoding is provided. The method includes receiving video data comprising a current image frame, encoding the current image frame including a current coding block, determining whether a bi-predictive IBC mode is enabled to code the current coding block of the current image frame with two reference coding blocks located in a reconstructed portion of the current image frame, transmitting the encoded current image frame via a video bitstream, and signaling, via the video bitstream, a first syntax element for the IBC mode indicating whether the current coding block of the current image frame is coded with the two reference coding blocks located in the reconstructed portion of the current image frame. When the first syntax element indicates that the bi-predictive IBC mode is enabled, a target weight is adaptively determined for the current coding block and used to combine the two reference coding blocks to predict the current coding block

In accordance with some embodiments, a method of bitstream conversion is provided. The method includes. The method includes obtaining a source video sequence including a current coding block of a current image frame and performing a conversion between the source video sequence and a video bitstream. The video bitstream includes the current image frame and a first syntax element for a bi-predictive IBC mode indicating whether to code the current coding block of the current image frame with two reference coding blocks located in a reconstructed portion of the current image frame. When the first syntax element indicates that the bi-predictive IBC mode is enabled, a target weight is adaptively determined for the current coding block and used to combine the two reference coding blocks to generate the current coding block.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and/or a decoder component.

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for coding video. Such methods, devices, and systems may complement or replace conventional methods, devices, and systems for video coding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments, and

FIG. 2B is a block diagram illustrating example elements of a decoder component in accordance with some embodiments.

FIG. 3 is a block diagram illustrating an example server system in accordance with some embodiments.

FIG. 4 is a flow diagram of an example process of predicting a current coding block in a bi-predictive IBC mode, in accordance with some embodiments.

FIG. 5 is a flow diagram illustrating a method of coding video, in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes methods, systems, and non-transitory computer-readable storage media for applying a bi-predictive intra block copy (IBC) mode to predict a current coding block. The current coding block is predicted with two block vectors (BV) identifying two reference coding bocks. A target weight is adaptively identified to combine samples of the two reference coding blocks, thereby enhancing flexibility of the bi-predictive IBC mode. In some embodiments, the target weight is selected from a list of predefined weights using an index signaled via a video bitstream. Alternatively, in some embodiments, the target weight is selected from a list of predefined weights based on a template matching cost. In some embodiments, the target weight is adaptively determined based on template matching costs of the reference coding blocks. The bi-predictive IBC mode using an adaptive weight improves the coding efficiency and accuracy of video content materials compared with the bi-predictive IBC mode that does not use the adaptive weight.

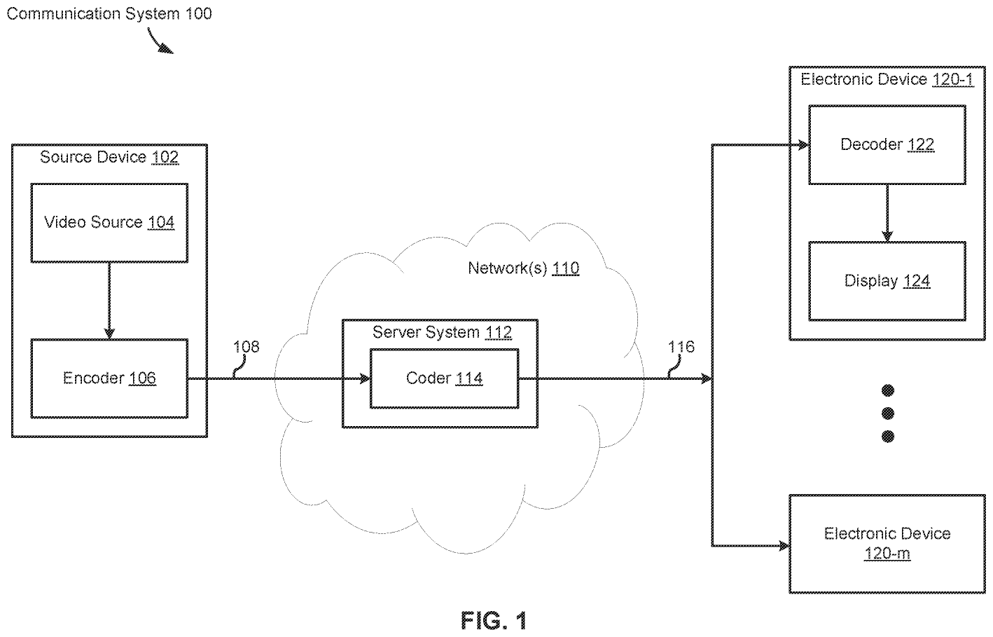

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

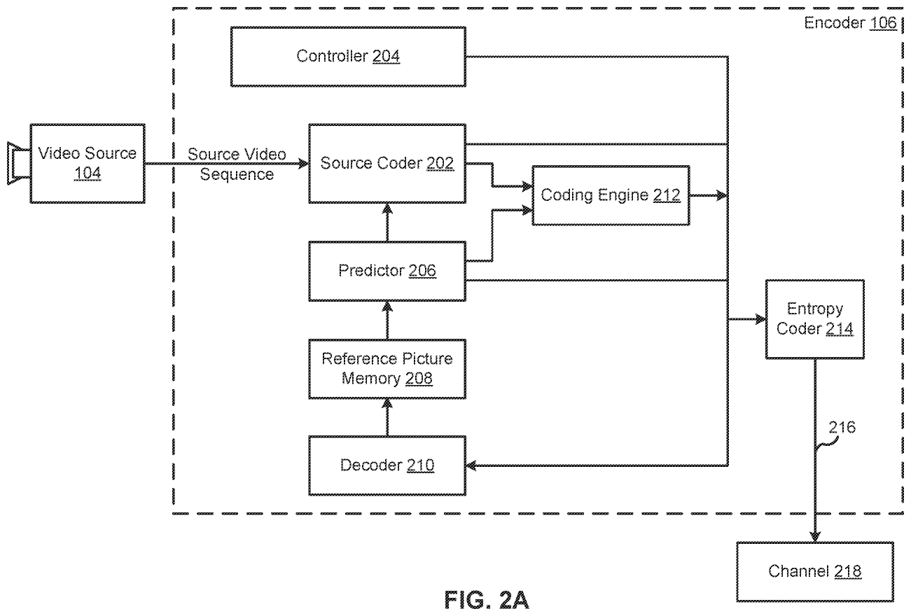

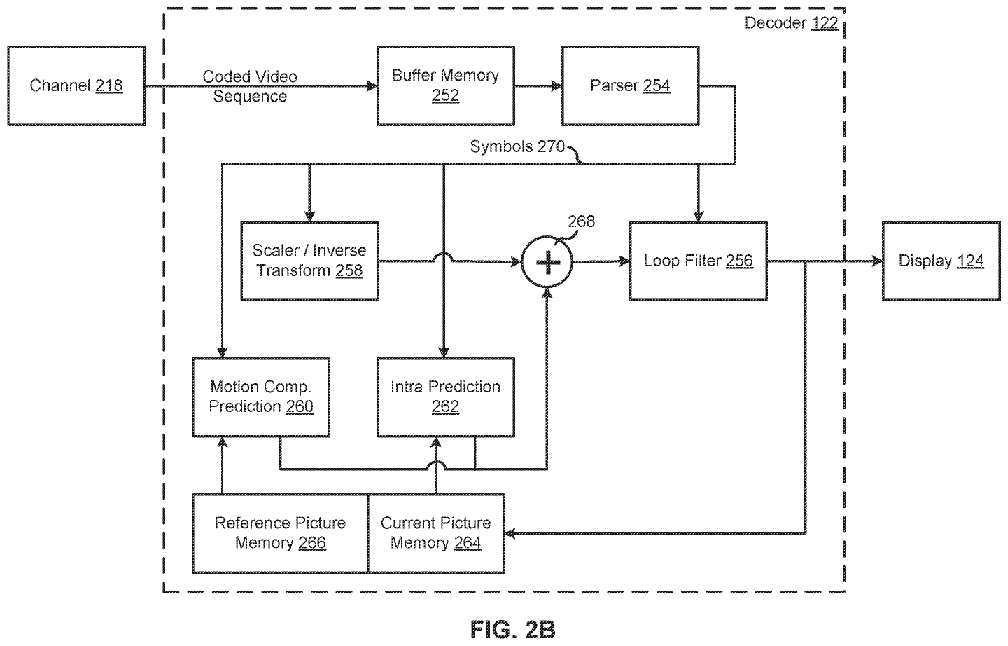

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed portions of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

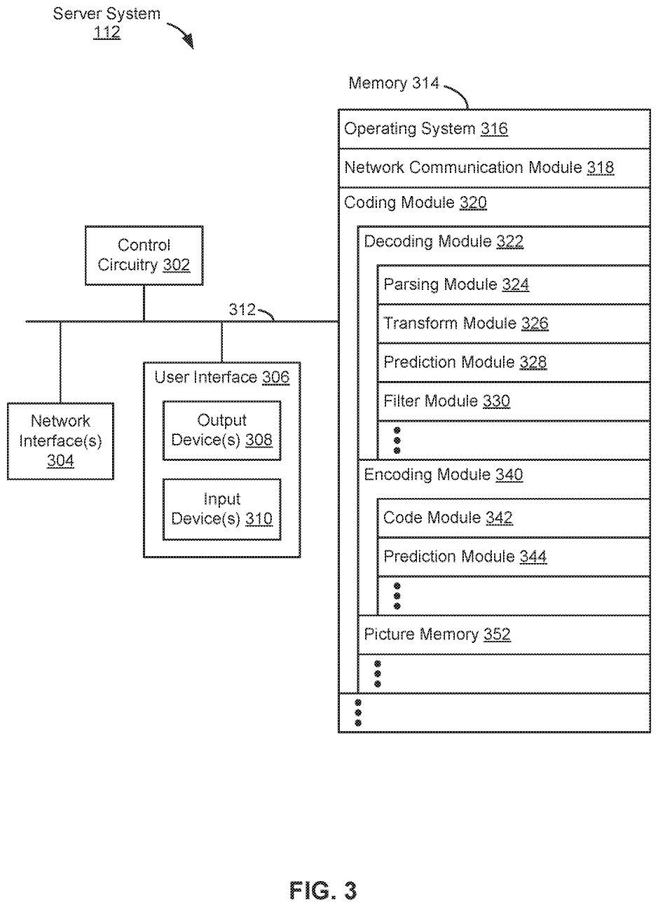

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above, such as an audio processing module.

Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

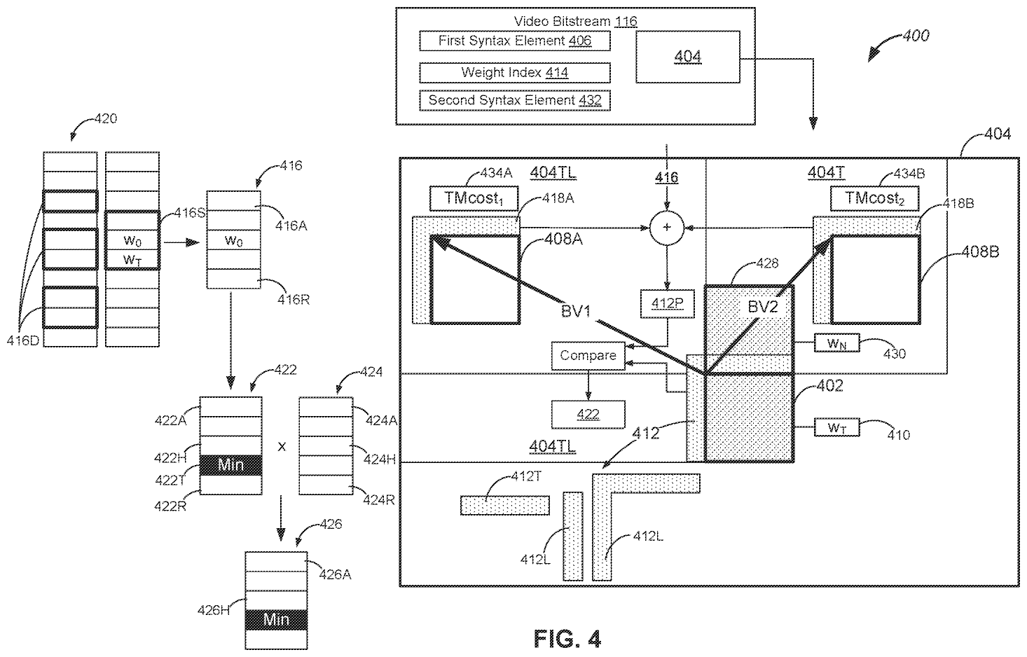

FIG. 4 is a flow diagram of an example process 400 of predicting a current coding block 402 in a bi-predictive IBC mode, in accordance with some embodiments. A GOP includes a sequence of image frames that further includes a current image frame 404. The current image frame 404 may include a color image, i.e., a non-monochrome image frame, which has a plurality of color samples (e.g., chroma samples and luma samples) co-located with one another. A video decoder 122 (FIG. 2B) receives a video bitstream 116 including the current image frame 404. The video bitstream 116 includes a first syntax element 406 for a bi-predictive intra block copy (IBC) mode. Based on the first syntax clement 406, it is determined that the current coding block 402 of the current image frame 404 is coded with two reference coding blocks 408A and 408B located in a reconstructed portion of the current image frame 404 according to the bi-predictive IBC mode. The two reference coding blocks 408A and 408B correspond to the current coding block 402. The video decoder 122 identifies the two reference coding blocks 408A and 408B in the reconstructed portion of the current image frame 404. A target weight 410 (w_{T}) associated with the two reference coding blocks 408A and 408B is adaptively determined for the current coding block 402. The two reference coding blocks 408A and 408B are combined based on the target weight 410 (w_{T}) to predict the current coding block 402. The video decoder 122 reconstructs the current image frame including the current coding block predicted using the target weight 410 (w_{T}). In some embodiments, the first syntax element 406 is signaled for the current coding block 402 on a coding block level.

In some embodiments, samples of the current coding block 402 are predicted based on the target weight 410 (w_{T}) as follows:

$$predSamples = {w}_{T} * {refBlock}_{1} + ( 1 - {w}_{T} ) * {refBlock}_{2} + {P}_{OFFSET} \qquad ( 1 )$$

where preSamples represents values of the samples of the current coding block 402; refBlock₁ and refBlock₂ represent samples of a first reference block 408A and a second reference block 408B, respectively; and P_{OFFSET} is an offset sample value. In an example, P_{OFFSET} is equal to 0. In another example, P_{OFFSET} is equal to 0.5. Alternatively, in some embodiments, samples of the current coding block 402 are predicted based on the target weight 410 (w_{T}) as follows:

$$predSamples = {w}_{T} * {refBlock}_{1} + {w}_{T}^{′} * {refBlock}_{2} + {P}_{OFFSET} \qquad ( 2 )$$

where w_{T}′ is a supplemental weight associated with the second reference block 408B, and the target weight 410 (w_{T}) is associated with the first reference block 408A. A sum of the weights w_{T} and w_{T}′ is not limited to 1.

In some embodiments, a first block vector BV1 is identified for the first reference block 408A, connecting the current coding block 402 to the first reference block 408A. A second block vector BV2 is identified for the second reference block 408B, connecting the current coding block 402 to the second reference block 408B. Both the first block vector BV1 and the second block vector BV2 point to block locations in the reconstructed portion in the current coding block 402. For example, the first reference block 408A is located in a top left reconstructed portion 404TL of the current coding block 402, and the first reference block 408A is located in a top reconstructed portion 404T of the current coding block 402.

In some embodiments, the video decoder 122 stores a list of predefined weights 420. The video bitstream 116 includes a weight index 414, and the video decoder 122 selects the target weight 410 (w_{T}) from the list of predefined weights 420 based on the weight index 414.

Alternatively, in some embodiments, the video decoder 122 stores a list of predefined weights 420, and the video bitstream 116 does not include the weight index 414. The video decoder 122 determines the target weight 410 (w_{T}) adaptively based on template matching. For intra prediction, template matching is a decoder-side block vector derivation method to find the closest match between a current template 412 of the current coding block 402 and a reference template 418A in the reconstructed portion of the current image frame 404. A template matching cost 422 is applied to determine whether the reference template 418A is the closest match of the current template 412. In an example, a sum of absolute differences (SAD) of corresponding samples of the reference template 418A and the current template 412 is used to determine the template matching cost 422. In the bi-predictive IBC mode, two closes matches are identified and correspond to two reference templates 418A and 418B. The current template 412 includes a block of samples that are immediately adjacent to the current coding block 402 and have been reconstructed. Each of the reference templates 418A and 418B has the same shape and the same size as the current template 412. In some embodiments, the current template 412 is selected from a top current template 412T located on top of the current coding block 402, a left current template 412L located to the left of the current coding block 402, and an L-shaped current template 412L sharing a top edge and a left edge of the current coding block 402.

More specifically, in some embodiments associated with template matching, the video decoder 122 obtains a list of predefined weights 420 and identifies a subset of predefined weights 416. For each of a subset of predefined weights 416, the video decoder 122 combines two reference templates 418A and 418B of the two reference coding blocks 408A and 488B based on the respective predefined weight 416 to generate a predicted template 412P of the current coding block 402. The predicted template 412P is compared to the current template 412 to determine a template matching cost 422 corresponding to the respective predefined weight 416. In some embodiments, the template matching cost 422 is determined based on an SAD of samples of the predicted template and samples of the current template. In accordance with the respective template matching cost 422 corresponding to one of the subset of predefined weights 416 satisfies with a predefined selection criterion, the one of the subset of predefined weights 416 as the target weight 410 (w_{T}). For example, in accordance with the predefined selection criterion, the respective template matching cost 422T corresponding to the target weight 410 (w_{T}) is equal to or less than the respective template matching cost 422 corresponding to any distinct remaining predefined weight 416R in the subset of predefined weights 416. Stated another way, the target weight 410 (w_{T}) corresponds to the smallest template matching cost 422T among the template matching costs 422 corresponding to the subset of predefined weights 416.

In some embodiments, the list of predefined weights 420 includes an ordered-sequence of predefined weights, e.g., arranged in an increasing or decreasing order. Examples of the list of predefined weights 420 include, but are not limited to, {−2, 3, 4, 5, 10}, {1, 2, 3, 4, 5, 6, 7}, and {1, 3, 4, 5, 7} in a unit of ⅛. In some embodiments, the subset of predefined weights 416 includes predefined weighted 416D that are distributed in the list of predefined weights 420. Alternatively, in some embodiments, the subset of predefined weights 416 includes predefined weights 416S that are successively located in the list of predefined weights 420. For example, the subset of predefined weights 416 includes an inherited bi-predicted weight w₀ and two neighboring weights in the list of predefined weights. The inherited bi-predicted weight w₀ is likely to result in a higher accuracy level than any other weight in the list of predefined weights 420. For example, if the inherited bi-predicted weight w₀ is 4, the subset of predefined weights 416 includes three weights {3, 4, 5} in the unit of ⅛. In some embodiments not shown, the subset of predefined weights 416 includes a center weight and an equal number (e.g., 2, 3, or above) of weights on both sides of the center weights in the list of predefined weights 420.

In some embodiments, the video decoder 122 applies a scale factor 424H (e.g., less than 1) to at least a respective template matching cost 422H corresponding to the inherited bi-predicted weight wo, thereby generating an updated template matching cost 426H. For example, the updated template matching cost 426H is compared with template matching costs 422 corresponding to remaining weights 416 that are distinct from the inherited bi-predicted weight wo to identify the respective template matching cost 422T corresponding to the target weight 410 (w_{T}).

In some embodiments, the current coding block 402 has a neighboring coding block 428, and the neighboring coding block 428 is coded using a neighboring weight 430 (w_{N}) in the bi-predictive IBC mode. For each of the subset of predefined weights 416 associated with the current coding block 402, the video decoder 122 determines a respective scale factor 424 based on the neighboring weight 430 (w_{N}) and applies the respective scale factor 424 to scale the respective template matching cost 422, generating a respective updated template matching cost 426. The respective template matching cost 426 corresponding to the target weight 410 (w_{T}) are generated based on the respective updated template matching costs 426 corresponding to the subset of predefined weights 416.

In some embodiments, a scale factor 424 is less than 1. The smaller the scale factor 424, the higher a chance of the respective updated template matching cost 426. For example, the subset of predefined weights 416 includes a first predefined weight 416A corresponding to an equal weight mode. A first scale factor 424A is applied to scale the respective template matching cost 422A corresponding to the first predefined weight 416A, generating an updated first template matching cost 426A. The first scale factor 424A is less than 1. Further, in some embodiments, the subset of predefined weights 416 further includes one or more remaining predefined weights 416R distinct from the first predefined weight 416A. For each of the one or more remaining weights 416R, the video decoder 122 applies a remaining scale factor 424R to scale the respective template matching cost 422R corresponding to the respective remaining weight 416R, thereby generating an updated remaining template matching cost 426R. The first scale factor 424A is equal to or less than the remaining scale factor 424R of each and every remaining weight 416R (e.g., which is complementary to the first predefined weight 416A). By these means, the first weight 416A has a higher chance of resulting in a smallest updated template matching cost 426 and being selected as the target weight 410 (w_{T}) compared with the one or more remaining predefined weights 416R.

In some embodiments, the video bitstream 116 further includes a second syntax clement 432 indicating whether the target weight 410 (w_{T}) of the current coding block 402 is determined based on two template matching costs 434A and 434B of the two reference coding blocks 408A and 408B. Further, in some embodiments, the two reference coding blocks 408A and 408B includes a first reference block 408A and a second reference block 408B. When the second syntax element is enabled, the video decoder 122 determines a first template matching cost 434A (TMcost₁) associated with the first reference block 408A, and a second template matching cost 434B (TMcost₂) associated with the second reference block 408B. The target weight 410 (w_{T}) is determined based on the first template matching cost 434A and the second template matching cost 434B as follows:

$${w}_{T} = \frac{T M {cost}_{2}}{T M {cost}_{1} + T M {cost}_{2}} . \qquad ( 3 )$$

A sample value P of the current template 412 is represented as a combination of two sample values P₁ and P₂ from the two reference templates 418A and 418B as follows:

$$P = \frac{T M {cost}_{2} \times {P}_{1} + T M {cost}_{1} \times {P}_{2}}{T M {cost}_{1} + T M {cost}_{2}} , \qquad ( 4 )$$

so is a sample value of the current coding block 402 represented as a combination of two sample values from the two reference coding blocks 408A and 408B. Further, in some embodiments, when the second syntax element 432 is disabled, the target weight 410 (w_{T}) is set based on an equal weight mode. In some embodiments, the second syntax element 432 includes a flag, and is signaled on a coding block level for the current coding block 402.

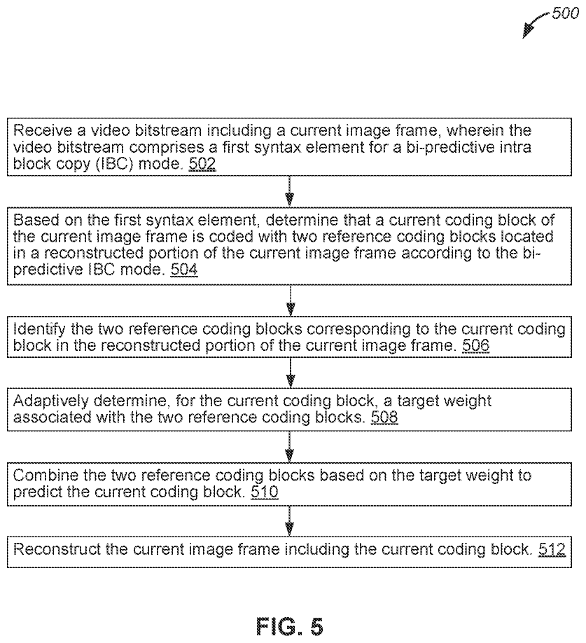

FIG. 5 is a flow diagram illustrating a method 500 of coding video, in accordance with some embodiments. A bi-predictive IBC mode is applied to predict prediction samples of a current coding block 402 based two block vectors BV1 and BV2 associated with two reference coding blocks 408A and 408B, which are located in a reconstructed portion of the current image frame 404. An adaptive target weight 410 (w_{T}) is applied to combine two prediction samples from the two reference coding blocks 408A and 408B identified by the two blocking vectors BV1 and BV2, thereby predicting an associated sample of the current coding block 402. In some embodiments, a bi-prediction with CU-level weight (BCW) is applied to combine the two prediction samples from the two reference coding blocks 408A and 408B. In some embodiments, intra template matching prediction (IntraTMP) is a special intra prediction mode that copies the best prediction block from the reconstructed portion of the current image frame 404, whose templates 418A or 418B (e.g., having an L-shape) match the current template 412. For a predefined search range, the encoder searches for the most similar template to the current template 412 in the reconstructed portion of the current image frame 404 and uses the corresponding block 408A or 408B as a prediction block. The encoder then signals the usage of this mode, and the same prediction operation is performed at the decoder side.

In some embodiments, an adaptive target weight 410 (w_{T}) is applied to combine two prediction blocks (e.g., the reference coding blocks 408A and 408B) from two different BVs (BV1 and BV2) when the current coding block is coded in a bi-predictive IBC mode. In some embodiments, a coding unit level syntax (e.g., a first syntax element 406) is signaled to select the index of the adaptive target weight 410 (w_{T}) from a predefined list of adaptive weights 420, e.g., a BCW weight in VVC and ECM. In some embodiments, template-matching is used to determine template matching costs on different adaptive weights. The adaptive weight corresponding to the smallest template matching cost is selected as the target weight 410 (w_{T}). In some embodiments, the template matching costs 422 for a subset of different adaptive weights 416 have different scale factors 424, depending on the adaptive weight usage of the neighboring coded block(s) 428.

In some embodiments, a scale factor 424A is applied to the template matching cost 422A in an equal weight mode (e.g., when the template matching cost 422 corresponds to a respective weight equal to 0.5). In an example, the scale factor 424A is less than 1 to make selection of the equal weight mode more frequent. In another example, the scale factor 424A is always the minimal scale factor over all other scale factors 424R to make selection of the equal weight mode more frequent that all other weights 416R.

In some embodiments, the template-matching costs 422 corresponding to the block vectors BV1 and BV2 are used to derive the adaptive weight (e.g., the target weight 410 (w_{T})). In an example, the template matching cost 422 (TMcost₁) is associated with a first prediction block P₁ (e.g., the first reference block 408A) corresponding to the first block vector BV1. The template matching cost 422 (TMcost₂) is associated with a second prediction block P₂ (e.g., the second reference block 408B) corresponding to the second block vector BV2. A weighting average of the bi-predictive blocks (e.g., the two reference coding blocks 408A and 408B) is represented based on equation (4).

In some embodiments, a coding unit level flag (e.g., a second syntax element 432) is signaled to indicate whether the template matching costs of the two reference coding blocks are directly used to determine the target weight 410 (w_{T}). If the flag is true (e.g., has a first value), the template matching costs of the two reference coding blocks are directly used to determine the target weight 410 (w_{T}). If the flag has a second value distinct from the first value, an equal weight is used, i.e., the target weight 410 (w_{T}) is equal to 0.5.

Although FIG. 5 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In some implementations, a method 500 is implemented for decoding video data. The method 500 includes receiving (operation 502) a video bitstream including a current image frame, wherein the video bitstream comprises a first syntax element for a bi-predictive intra block copy (IBC) mode; based on the first syntax element, determining (operation 504) that a current coding block of the current image frame is coded with two reference coding blocks located in a reconstructed portion of the current image frame according to the bi-predictive IBC mode; identifying (operation 506) the two reference coding blocks corresponding to the current coding block in the reconstructed portion of the current image frame; adaptively determining (operation 508), for the current coding block, a target weight associated with the two reference coding blocks; combining (operation 510) the two reference coding blocks based on the target weight to predict the current coding block; and reconstructing (operation 512) the current image frame including the current coding block.

(A2) In some embodiments of A1, the two reference coding blocks includes a first reference block and a second reference block, the method the method 500 further includes identifying a first block vector associated with the first reference block; and identifying a second block vector associated with the second reference block.

(A3) In some embodiments of A1 or A2, the method 500 further includes selecting the target weight from a list of predefined weights based on a weight index, wherein the weight index is received with the video bitstream.

(A4) In some embodiments of A1 or A2, the method 500 further includes obtaining a list of predefined weights; for each of a subset of predefined weights, combining two reference templates of the two reference coding blocks based on the respective predefined weight to generate a predicted template of the current coding block; determining a respective template matching cost based on the predicted template and a current template of the current coding block; and in accordance with the respective template matching cost corresponding to one of the subset of predefined weights satisfies with a predefined selection criterion, setting the one of the subset of predefined weights as the target weight.

(A5) In some embodiments of A4, in accordance with the predefined selection criterion, the respective template matching cost corresponding to the target weight is equal to or less than the respective template matching cost corresponding to any distinct remaining predefined weight in the subset of predefined weights.

(A6) In some embodiments of A4 or A5, the subset of predefined weights includes an inherited bi-predicted weight and two neighboring weights in the list of predefined weights, the method the method 500 further includes applying a scale factor to at least the respective template matching cost corresponding to the inherent bi-predicted weight.

(A7) In some embodiments of any of A4-A6, the method 500 further includes identifying a neighboring coding block, of the current coding block, which is coded using a neighboring weight in the bi-predictive IBC mode; and for each of the subset of predefined weights, determining a respective scale factor based on the neighboring weight and applying the respective scale factor to scale the respective template matching cost.

(A8) In some embodiments of any of A4-A7, the subset of predefined weights includes a first predefined weight corresponding to an equal weight mode, the method the method 500 further includes applying a first scale factor to scale the respective template matching cost corresponding to the first predefined weight, wherein the first scale factor is less than 1.

(A9) In some embodiments of A8, the subset of predefined weights further includes one or more remaining predefined weights distinct from the first predefined weight, the method the method 500 further includes for each of the one or more remaining weights, applying a remaining scale factor to scale the respective template matching cost corresponding to the respective remaining weight; wherein the first scale factor is equal to or less than the remaining scale factor of each and every remaining weight.

(A10) In some embodiments of any of A4-A9, determining the respective template matching cost for each of the subset of predefined weights further includes determining a sum of absolute differences (SAD) of samples of the predicted template and samples of the current template.

(A11) In some embodiments of A1 or A2, the video bitstream further includes a second syntax element indicating whether the target weight of the current coding block is determined based on two template matching costs of the two reference coding blocks.

(A12) In some embodiments of A11, the two reference coding blocks includes a first reference block and a second reference block, the method further comprising, when the second syntax element is enabled: determining a first template matching cost associated with the first reference block; determining a second template matching cost associated with the second reference block; and determining the target weight based on the first template matching cost and the second template matching cost.

(A13) In some embodiments of A12, samples of the two reference coding blocks are combined based on the target weight to predict a sample of the current coding block as follows:

$$P = \frac{T M {cost}_{2} \times {P}_{1} + T M {cost}_{1} \times {P}_{2}}{T M {cost}_{1} + T M {cost}_{2}}$$

where P₁, P₂, and P represent samples values of the samples of the two reference coding blocks and the current coding block, respectively, and TMcost₁ and TMcost₂ represent the first template matching cost and the second template matching cost, respectively.

(A14) In some embodiments of A11, determining the target weight further comprises when the second syntax element is disabled, setting the target weight based on an equal weight mode.

(A15) In some embodiments of any of A11-A14, the second syntax element includes a flag, and is signaled for the current coding block on a coding block level.

(A16) In some embodiments of any of A1-A15, the first syntax element is signaled for the current coding block on a coding block level.

(A17) In some embodiments, a method of video encoding includes: receiving video data comprising a current image frame; encoding the current image frame including a current coding block; determining whether a bi-predictive intra block copy (IBC) mode is enabled to code the current coding block of the current image frame with two reference coding blocks located in a reconstructed portion of the current image frame; transmitting the encoded current image frame via a video bitstream; and signaling, via the video bitstream, a first syntax element for the IBC mode indicating whether the current coding block of the current image frame is coded with the two reference coding blocks located in the reconstructed portion of the current image frame; wherein when the first syntax element indicates that the bi-predictive IBC mode is enabled, a target weight is adaptively determined for the current coding block and used to combine the two reference coding blocks to predict the current coding block.

(A18) In some embodiments, a method of bitstream conversion includes: obtaining a source video sequence including a current coding block of a current image frame; and performing a conversion between the source video sequence and a video bitstream, wherein the video bitstream comprises: the current image frame; and a first syntax element for a bi-predictive intra block copy (IBC) mode indicating whether to code the current coding block of the current image frame with two reference coding blocks located in a reconstructed portion of the current image frame; wherein when the first syntax element indicates that the bi-predictive IBC mode is enabled, a target weight is adaptively determined for the current coding block and used to combine the two reference coding blocks to predict the current coding block.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A18 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A18 above).

The proposed methods may be used separately or combined in any order. Further, each of the methods (or embodiments), encoder, and decoder may be implemented by processing circuitry (e.g., one or more processors or one or more integrated circuits). For example, the one or more processors execute a program that is stored in a non-transitory computer-readable medium. In the following, the term block may be interpreted as a prediction block, a coding block, or a coding unit, i.e., CU.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for decoding video data, comprising:
receiving a video bitstream including a current image frame, wherein the video bitstream comprises a first syntax element for a bi-predictive intra block copy (IBC) mode;
based on the first syntax element, determining that a current coding block of the current image frame is coded with two reference coding blocks located in a reconstructed portion of the current image frame according to the bi-predictive IBC mode;
identifying the two reference coding blocks corresponding to the current coding block in the reconstructed portion of the current image frame;
adaptively determining, for the current coding block, a target weight associated with the two reference coding blocks;
combining the two reference coding blocks based on the target weight to predict the current coding block; and
reconstructing the current image frame including the current coding block.

2. The method of claim 1, wherein the two reference coding blocks includes a first reference block and a second reference block, the method further comprising:
identifying a first block vector associated with the first reference block; and
identifying a second block vector associated with the second reference block.

3. The method of claim 1, further comprising:
selecting the target weight from a list of predefined weights based on a weight index, wherein the weight index is received with the video bitstream.

4. The method of claim 1, further comprising:
obtaining a list of predefined weights;
for each of a subset of predefined weights,
combining two reference templates of the two reference coding blocks based on the respective predefined weight to generate a predicted template of the current coding block;
determining a respective template matching cost based on the predicted template and a current template of the current coding block; and
in accordance with the respective template matching cost corresponding to one of the subset of predefined weights satisfies with a predefined selection criterion, setting the one of the subset of predefined weights as the target weight.

5. The method of claim 4, wherein in accordance with the predefined selection criterion, the respective template matching cost corresponding to the target weight is equal to or less than the respective template matching cost corresponding to any distinct remaining predefined weight in the subset of predefined weights.

6. The method of claim 4, wherein the subset of predefined weights includes an inherited bi-predicted weight and two neighboring weights in the list of predefined weights, the method further comprising:
applying a scale factor to at least the respective template matching cost corresponding to the inherent bi-predicted weight.

7. The method of claim 4, further comprising:
identifying a neighboring coding block, of the current coding block, which is coded using a neighboring weight in the bi-predictive IBC mode; and
for each of the subset of predefined weights, determining a respective scale factor based on the neighboring weight and applying the respective scale factor to scale the respective template matching cost.

8. The method of claim 4, wherein the subset of predefined weights includes a first predefined weight corresponding to an equal weight mode, the method further comprising:
applying a first scale factor to scale the respective template matching cost corresponding to the first predefined weight, wherein the first scale factor is less than 1.

9. The method of claim 8, wherein the subset of predefined weights further includes one or more remaining predefined weights distinct from the first predefined weight, the method further comprising:
for each of the one or more remaining weights, applying a remaining scale factor to scale the respective template matching cost corresponding to the respective remaining weight;
wherein the first scale factor is equal to or less than the remaining scale factor of each and every remaining weight.

10. The method of claim 4, wherein determining the respective template matching cost for each of the subset of predefined weights further includes:
determining a sum of absolute differences (SAD) of samples of the predicted template and samples of the current template.

11. The method of claim 1, wherein the video bitstream further includes a second syntax element indicating whether the target weight of the current coding block is determined based on two template matching weights of the two reference coding blocks.

12. The method of claim 11, wherein the two reference coding blocks includes a first reference block and a second reference block, the method further comprising, when the second syntax element is enabled:
determining a first template matching cost associated with the first reference block;
determining a second template matching cost associated with the second reference block; and
determining the target weight based on the first template matching cost and the second template matching cost.

13. The method of claim 12, wherein samples of the two reference coding blocks are combined based on the target weight to predict a sample of the current coding block as follows:
$$P = \frac{T M {cost}_{2} \times {P}_{1} + T M {cost}_{1} \times {P}_{2}}{T M {cost}_{1} + T M {cost}_{2}}$$
where P₁, P₂, and P represent samples values of the samples of the two reference coding blocks and the current coding block, respectively, and TMcost₁ and TMcost₂ represent the first template matching cost and the second template matching cost, respectively.

14. The method of claim 11, wherein determining the target weight further comprises:
when the second syntax element is disabled, setting the target weight based on an equal weight mode.

15. The method of claim 11, wherein the second syntax element includes a flag, and is signaled for the current coding block on a coding block level.

16. The method of claim 1, wherein the first syntax element is signaled for the current coding block on a coding block level.

17. A computing system, comprising:
control circuitry; and
memory storing one or more programs configured to be executed by the control circuitry, the one or more programs further comprising instructions for:
receiving video data comprising a current image frame;
encoding the current image frame including a current coding block;
determining whether a bi-predictive intra block copy (IBC) mode is enabled to code the current coding block of the current image frame with two reference coding blocks located in a reconstructed portion of the current image frame;
transmitting the encoded current image frame via a video bitstream; and
signaling, via the video bitstream, a first syntax element for the IBC mode indicating whether the current coding block of the current image frame is coded with the two reference coding blocks located in the reconstructed portion of the current image frame;
wherein when the first syntax element indicates that the bi-predictive IBC mode is enabled, a target weight is adaptively determined for the current coding block and used to combine the two reference coding blocks to predict the current coding block.

18. The computing system of claim 17, wherein the one or more programs further comprise instructions for:
selecting the target weight from a list of predefined weights based on a weight index, wherein the weight index is received with the video bitstream.

19. A non-transitory computer-readable storage medium storing one or more programs for execution by control circuitry of a computing system, the one or more programs comprising instructions for:
obtaining a source video sequence including a current coding block of a current image frame; and
performing a conversion between the source video sequence and a video bitstream, wherein the video bitstream comprises:
the current image frame; and
a first syntax element for a bi-predictive intra block copy (IBC) mode indicating whether to code the current coding block of the current image frame with two reference coding blocks located in a reconstructed portion of the current image frame;
wherein when the first syntax element indicates that the bi-predictive IBC mode is enabled, a target weight is adaptively determined for the current coding block and used to combine the two reference coding blocks to predict the current coding block.

20. The non-transitory computer-readable storage medium of claim 19, wherein the one or more programs further comprise instructions for:
obtaining a list of predefined weights;
for each of a subset of predefined weights,
combining two reference templates of the two reference coding blocks based on the respective predefined weight to generate a predicted template of the current coding block;
determining a respective template matching cost based on the predicted template and a current template of the current coding block; and
in accordance with the respective template matching cost corresponding to one of the subset of predefined weights satisfies with a predefined selection criterion, setting the one of the subset of predefined weights as the target weight.
